(19) United States
(12) Patent Application Publication
(10) Pub. No.: US 2006/0161488 A1
(43) Pub. Date: Jul. 20, 2006

(54) Data confirming system and data confirming method

(75) Inventor: Osamu Satou, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/168,320

(22) Filed: Jun. 29, 2005

(30) Foreign Application Priority Data
Jan. 14, 2005 (JP) 2005-007352

(51) Int. Cl. G06Q 40/00

(52) U.S. Cl. 705/35

(57) ABSTRACT

What is disclosed is a data confirming system comprising: an image reader for reading an image of a manuscript written in a financial sheet, a character reader for transforming said image to a text data corresponding to said image data, a data dividing section for dividing said image and said text data, into each item in said financial sheet, a searching data obtaining section for obtaining a searching data from said text data divided into said item, a searching data confirming section for confirming said searching data, a database for storing each financial trade data made in each past financial trade, a data searching section for searching said database for a financial trade data corresponding to said searching data, and a data distributing section for distributing each item of said financial trade data to each of confirming terminals, after extracting each item of said financial trade data from said financial trade data.

### BACKGROUND OF THE INVENTION

1. Field of the Invention

The present invention relates to a data confirming system and a data confirming method, which are able to assemble each financial trade performed by each financial organ, and which can increase efficiency of a process of financial trades.

2. Description of Related Art

When a client at a financial organ performs a financial trade, the client offers to a receptionist a financial sheet on which the client writes by manuscript, for example, a number of a deposit of the client, a division of the deposit, a name of the deposit, data of a deposit of a remittee etc. Then, the financial sheet is inserted to an entry terminal. There, an OCR (optical character reader) performs a reading process of characters, so as to generate each text data corresponding to each image of a character.

In this case, an operator of the financial organ confirms each text data obtained from each image data by comparing each text data presented at a screen of a confirming terminal, with each image data of manuscript from which the text data is generated, in order to confirm that no error exists in each text data obtained from each image data of manuscript. In case when the operator detects an error in a text data, the operator corrects the text data according to the corresponding image data.

Meanwhile, the above mentioned process of confirming each text data written on a financial sheet by manuscript is also performed in other financial organ. Therefore, each confirming process performed in different financial organ can be performed by a same equipment, by assembling each job of confirming each financial trade data, so as to reduce cost for equipments and persons.

In a conventional data confirming method, said financial trade data read from said financial sheets for financial trades are assembled to a cooperation center, where each financial trade data is distributed to each operator. And, each operator confirms each financial trade data. That is, an operator deals with whole of a financial trade. Therefore, the operator can know a content of each financial trade written in each financial sheet. Then, the operator must be a confidential person, because the person deals with a secret of each financial trade. Otherwise, the secret may be revealed.

In another conventional data confirming method, each financial trade data written in each financial sheet is divided into each item, which is distributed to each confirming terminal where each item of financial trade data is confirmed by each of plural operators. After this, each item of financial trade data confirmed is combined to a financial trade data so as to execute a financial trade.

However, in case of, for example, a financial trade of a remitting, the remitting is often same as a past remitting. In this case, the client writes a same financial data on a financial sheet. And, a same above mentioned confirming process is performed by each of plural operators.

Therefore, many duplicated confirming processes are performed by plural operators. And, cost for persons and equipment to use, is increased.

### SUMMARY OF THE INVENTION

The present invention is aimed at increasing efficiency of a confirming process of a financial trade data, by using past financial trade data stored in a database.

According to one aspect of the present invention, there is provided a data confirming system comprising: an image reader for reading an image of a manuscript written on a financial sheet, a character reader for transforming said image to each of text data corresponding to said image, a data dividing section for dividing said image and said text data, into each item in said financial sheet, a searching data obtaining section for obtaining a searching data from said text data divided into said item, a searching data confirming section for confirming said searching data, a database for storing each financial trade data composed of a text data made in each past financial trade, a data searching section for searching said database for a financial trade data corresponding to said searching data, and a data distributing section for distributing each item of said financial trade data to each of confirming terminals, after extracting each item of said financial trade data from said financial trade data.

According to another aspect of the present invention, there is provided a data confirming method comprising steps of: reading an image of a manuscript written on a financial sheet, transforming said image to each of text data corresponding to said image, dividing said image and said text data, into each item in said financial sheet, obtaining a searching data from said text data divided into said item, confirming said searching data, searching a database, corresponding to said searching data, for a financial trade data made in each past financial trade, extracting each item of said financial trade data from said financial trade data, and distributing each item of said financial trade data to each of confirming terminals.

### BRIEF DESCRIPTION OF THE DRAWINGS

FIG. 1 is a block diagram showing a data confirming system of the present invention;

FIG. 2 is showing a configuration of data in a database;

FIG. 3 is a block diagram showing a configuration of a data distributing section;

FIG. 4 is a flow chart showing an operation of a data confirming system of the present invention;

FIGS. 5A and 5B show each presentation of each presenting screen of each confirming terminal.

### DESCRIPTION OF THE PREFERRED EMBODIMENTS

### Embodiment 1

<Configuration>

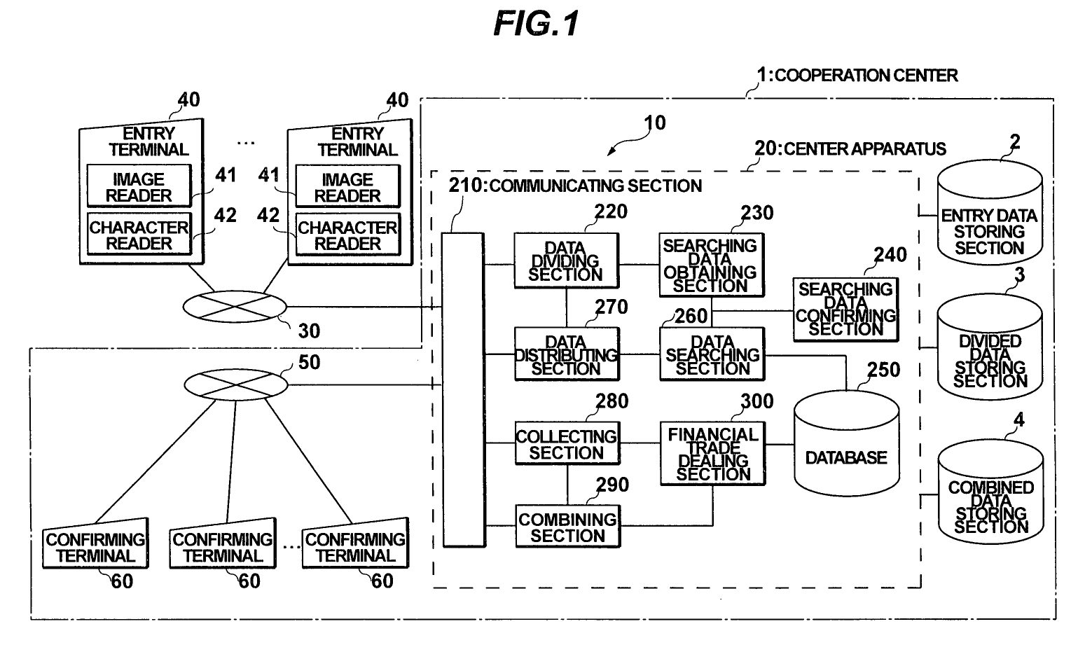

As shown in FIG. 1, a data confirming system of the present invention is comprising a center apparatus 20 installed in a cooperation center 1, entry terminals 40 of plural financial organs connected with the cooperation center 1 via a first network 30, and plural confirming terminals 60 connected with the cooperation center 1 via a second network 50.

Each entry terminal 40 is installed in each financial organ where each process of each financial trade is cooperated. Each entry terminal 40 has an image reader 41, and a character reader 42. The image reader 41 comprises an optical scanner of an image, which obtains an image data from an image written by manuscript on a financial sheet. The character reader 42 comprises an OCR (optical character reader), which generates text data by recognizing each image data of characters obtained by the image reader 41. The entry terminal 40 generates data comprising text data and image data mentioned above, based on a financial trade data generated from a financial sheet of each financial trade. And, the entry terminal 40 sends the data to the center apparatus 20 via the first network 30.

Incidentally, there is a processing apparatus of an association of financial organs not shown in the drawings, between the entry terminals 40 and the center apparatus 20. Therefore, each entry terminal 40 installed in each financial organ is connected with the processing apparatus of the association of financial organs by a network. Thereby, data from each entry terminal 40 is temporarily collected by the processing apparatus of the association of financial organs. And, after that, the data collected is sent to the center apparatus 20 from the processing apparatus of the association of financial organs.

The confirming terminals 60 have functions of presenting data, inputting data, and communicating data. The confirming terminal 60 is connected with the second network 50 comprising LAN (local area network) in the cooperation center 1. To this second network 50, a center apparatus 20 is connected. Thereby, the confirming terminals 60 perform data communications with the center apparatus 20 via the second network 50.

When the confirming terminals 60 obtain data comprising a text data and a corresponding image data of a content of a financial sheet divided into each item at the center apparatus 20, each of the confirming terminals 60 present the data at each of screens. Then, the text data and the image data are presented at a same screen. Thereby, an operator at each of the confirming terminals 60 performs a confirming process of comparing the text data and the image data, to judge whether the content of the text data and the content of the image data are same or not.

Meanwhile, when the text data, which is obtained from a financial sheet by a process of an OCR at the entry terminals 40, is presented at the screen of the confirming terminals 60, in case when an error in the process of the OCR, the content of the text data is different from the content of the image data. The operator at the confirming terminals 60 confirms an error by confirming an existence of a difference between the content of the text data and the content of the image data. When the operator confirms an error, the operator corrects the error in the text data.

A center apparatus 20 comprises a communicating section 210 for performing a control process of connecting with a network, a data dividing section 220 for dividing data comprising the text data and the image data obtained from the entry terminals 40, into each item, a searching data obtaining section 230 for obtaining the data of a client and the data of a trade accepter, as a searching data, a searching data confirming section 240 for performing a confirming process of the searching data, a database 250 for storing each past financial trade data, a data searching section 260 for searching the database 250 for a past financial trade data which is same as the data obtained from the entry terminals 40, a data distributing section 270 for performing a distributing process of obtaining the text data of a client and the text data of a trade accepter from the past financial trade data obtained from the database 250, and distributing these text data instead of the text data obtained from the entry terminals 40, a collecting section 280 for collecting each result of a confirming process performed at each confirming terminals 60, a combining section 290 for generating a set of text data comprising a financial trade data, by combining each result of said confirming process, and a financial trade dealing section 300 for dealing a financial trade based on the set of the text data comprising a financial trade data, and storing the set of the text data in said database 250.

In the cooperation center 1, an entry data storing section 2, a divided data storing section 3, and a combined data storing section 4 are connected with the center apparatus 20. As shown in FIG. 1, these storing sections 2, 3, 4 are able to communicate with the center apparatus 20.

The entry data storing section 2 stores data comprising text data and image data which the communicating section 210 receives from the entry terminals 40. In this case, each of the data comprising the text data and the image data are attached with each number of serial numbers. Moreover, each item of said data is attached with a searching flag of indicating whether said item is a searching data or not, a replacing flag of indicating whether said item should be replaced by a data obtained from the database 250 after searching the database 250.

The divided data storing section 3 stores each data divided by the data dividing section 220 into each item with each of said serial numbers. Each data divided and stored in the divided data storing section 3 is sent to each of the confirming terminals 60 via the data distributing section 270.

The combined data storing section 4 stores a combined data which is generated by combining each data confirmed and sent from each of the confirming terminals 60, based on a number of said serial number.

Each item of the combined data is same as each item of the entry data, except that each item of the combined data is attached with each confirming flag of indicating whether each item is confirmed by each of the confirming terminals 60 or not.

As mentioned above, each of the storing sections 2, 3, 4 are used for performing a dividing process of the entry data and for performing a combining process of the confirmed data.

Incidentally, as the item of the combining data storing section 4 is same as the item of the entry data storing section 2 except the confirming flag, both storing section 2 and 4 may be unified so as to reduce a capacity of the storing sections. In this case, each item of the confirmed data sent from each of the confirming terminals 60 are overlapped on each item of the entry data stored in the entry data storing section 2, with turning on each of confirming terminals attached with each item of the entry data.

The data dividing section 220 divides the data comprising the text data and the image data obtained from the entry terminals 40 into each item, for example, a telephone number of the client, a family name and first name of the client, an address of the client, a name of a financial organ of the client, a name of a branch of the client, a number of a deposit of the client, a division of a deposit of the client, a family name and first name of the trade accepter, a telephone number of the trade accepter, an address of the trade accepter, a name of a financial organ of the trade accepter, a name of a branch of the trade accepter, a number of a deposit of the trade accepter, a division of a deposit of the trade accepter, a discrimination of the trade, an amount of money of the trade, and a date of the trade. The items of financial sheet differ according to a kind of a financial trade, which may be a remitting process, a exchanging process, or a transferring process.

Each item of the data comprising the text data and the image data divided by the data dividing section 220 is distributed to each of the confirming terminals 60 so as to perform a confirming process.

Therefore, each operator of the confirming terminals 60 can know only each item of the financial trade data. That is, each operator cannot know the financial trade data as a whole, which includes the data of indicating who is the client (remitter), who is the trade accepter (remittee), what is the trade (an amount of money, a date). Therefore, each private data is prevented from revealed by the operator.

The searching data obtaining section 230 obtains from each item of data divided by the data dividing section 220, a searching data for a client data and a searching data for a trade accepter data. To be more concrete, the searching data obtaining section 230 obtains as a client data, a text data and an image data indicating a telephone number of a client (a remitter in case of a remitting process), and as a trade accepter data, a text data and an image data indicating a deposit number of a trade accepter (a remittee in case of a remitting process), and a text data and an image data indicating a deposit division of a trade accepter. Incidentally, although, in this Embodiment 1, as for a data specifying a client, a telephone number of a client is adopted; the present invention is not to limited to this. A deposit number of a client or a deposit number and division of a client can be adopted, instead of a telephone number of a client.

The searching data confirming section 240 performs a confirming process of a searching data obtained by the searching data obtaining section 230. That is, the searching data confirming section 240 confirms the data comprising the text data and the image data divided into a telephone number of the client, a number of a deposit of the trade accepter, and a division of a deposit of the trade accepter, by an operator at the center apparatus 20. In this case, the operator at the center apparatus 20 corrects each of the text data of a telephone number of the client, a number of a deposit of the trade accepter, and a division of a deposit of the trade accepter, according to each of the image data. And, the searching data confirming section 240 watches each confirming flag of a telephone number of the client, a number of a deposit of the trade accepter, and a division of a deposit of the trade accepter. When all of these flags are turned on, the searching data confirming section 240 sends the confirmed text data of a telephone number of the client, a number of a deposit of the trade accepter, and a division of a deposit of the trade accepter, to the database searching section 260.

On the other hand, as mentioned later, the data distributing section 270 distributes each item of the text data and the image data divided by the data dividing section 220, for example, a family name and first name of the client, an address of the client, a name of a financial organ of the client, a name of a branch of the client, a family name and first name of the trade accepter, a name of a financial organ of the trade accepter, a name of a branch of the trade accepter, a discrimination of the trade, an amount of the trade, and a date of the trade; to each of the confirming terminals 60. Here, as mentioned later, a data replacing section 274 in the data distributing section 270 replaces some of the items of the text data by a text data of a past financial trade obtained from the database 250. Then, each operator at each of the confirming terminals 60, confirms each item of the text data, according to the image data. And, each operator at each of the confirming terminals 60, corrects each item of the text data, according to the image data.

The database searching section 260 searches the database 250, based on the searching data confirmed, and it obtains from the database a past financial trade data corresponding to the searching data.

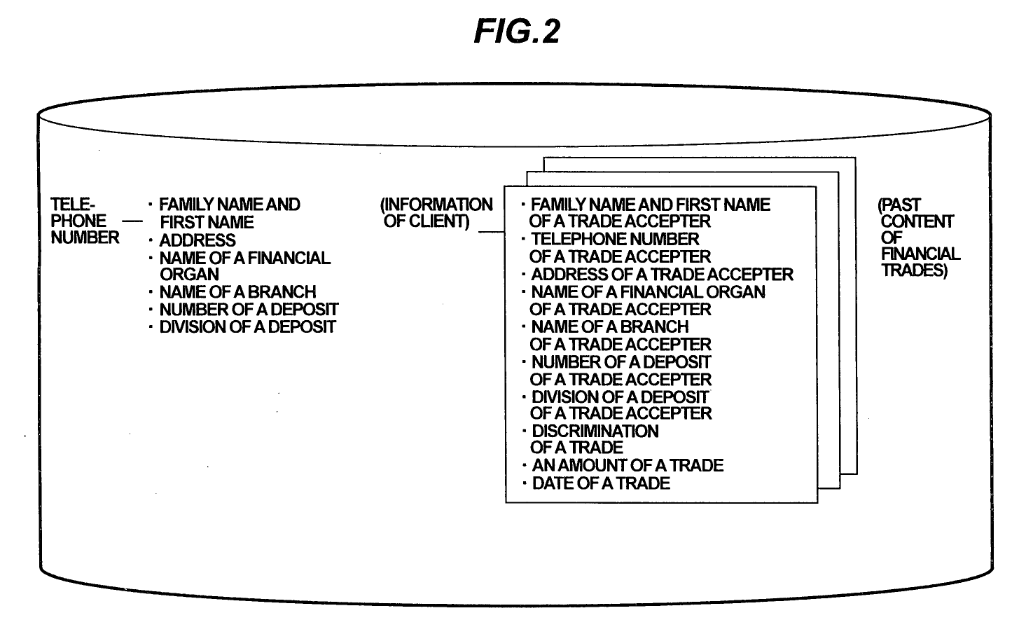

As shown in FIG. 2, the database 250 stores each text data of each client corresponding to each telephone number of the client, and it stores each text data of each trade accepter corresponding to each text data of each client.

The database 250 manages corresponding to a telephone number of the client, each data of a client. It is a family name and first name of the client, an address of the client, a name of a financial organ of the client, a name of a branch of the financial organ of the client, a number of a deposit of the client, and a division of a deposit of the client.

The database 250 manages corresponding to each data of a client, each data of each past trade. It is a family name and first name of the trade accepter, a telephone number of the trade accepter, an address of the trade accepter, a name of a financial organ of the trade accepter, a name of a branch of the trade accepter, a number of a deposit of the trade accepter, a division of a deposit of the trade accepter, a discrimination of the trade, an amount of the trade, and a date of the trade.

Therefore, the database 250 manages to search by, for example, a telephone number of the client, to obtain each data of a client, that is, a family name and first name of the client, a name of a financial organ of the client, a name of a branch of the financial organ of the client, a number of a deposit of the client, and a division of a deposit of the client.

And, the database 250 manages to search by each data of a client, to obtain each data of each past trade, that is, a family name and first name of the trade accepter, a telephone number of the trade accepter, an address of the trade accepter, a name of a financial organ of the trade accepter, a name of a branch of the trade accepter, a number of a deposit of the trade accepter, a division of a deposit of the trade accepter, and a discrimination of the trade.

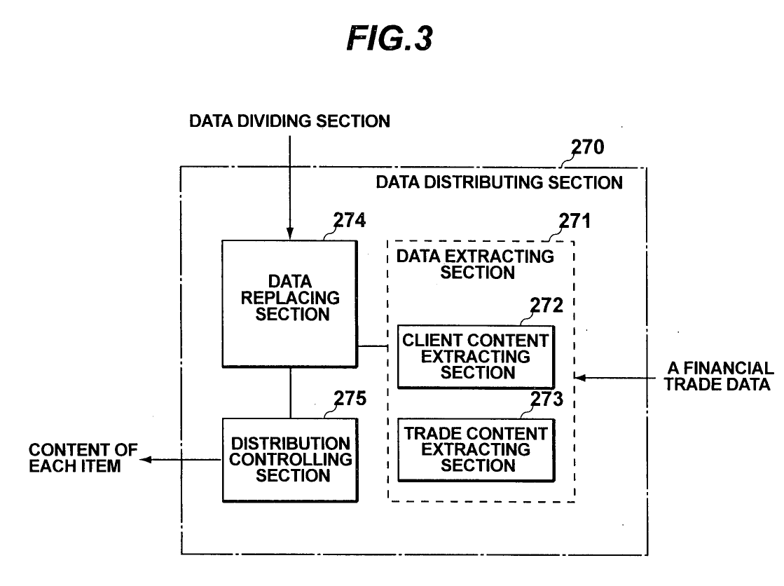

As shown in FIG. 3, the data distributing section 270 comprises a data extracting section 271 for analyzing a past financial trade data obtained by the database searching section 260 and for obtaining each text data of each client and each trade accepter, a data replacing section 274 for replacing the text data obtained from the entry terminal 40 with the text data obtained from the database 250, and a distribution controlling section 275 for distributing each text data and each image data to each confirming terminal 60.

The data extracting section 271 comprises a client content extracting section 272, and a trade content extracting section 273.

The client content extracting section 272 extracts a family name and first name of the client, a name of a financial organ of the client, a name of a branch of the financial organ of the client, a number of a deposit of the client, and a division of a deposit of the client; from a past financial trade data obtained by the database searching section 260.

The trade content extracting section 273 extracts a family name and first name of the trade accepter, a name of a financial organ of the trade accepter, a name of a branch of the trade accepter etc.; from a past financial trade data obtained by the database searching section 260.

Each of data mentioned above, which are obtained by the client content extracting section 272 and the trade content extracting section 273, are obtained corresponding to each item of data divided by the data dividing section 220.

The data replacing section 274 replaces each item of the text data divided by the data dividing section 274, with each item of the text data extracted by the data extracting section 271 from a past financial trade data corresponding to the text data. That is, the data replacing section 274 replaces each item of a name of a financial organ of a client, a name of a branch of the financial organ, a number of a deposit of the client, a division of the deposit, a name of a trade accepter, a telephone number of the trade accepter, a name of a branch of the trade accepter etc. with each item of the text data extracted by the data extracting section 271.

The distribution controlling section 275 distributes each item of the text data replaced by the data replacing section 274 and each item of the image data corresponding to each item of the text data. In this case, the distributing controlling section 275 has a data for deciding which confirming terminal 60 it sends the item of the text data to be confirmed.

Moreover, the distributing controlling section 275 distributes some item whose replacing flag is off, for example, an amount of money of a trade, a date of a trade etc. to the corresponding confirming terminals 60 as soon as the text data of them are obtained by the data dividing section 220, because these data are not necessary for waiting for searching the database 250.

The data collecting section 280 collects each item of the text data confirmed by each of the confirming terminals 60 via the communicating section 210.

The data combining section 290 combines each item of the text data, based on a corresponding number of said serial numbers, and it stores a result of combining the text data, in the combining data storing section 4. Thereby, a text data for performing a financial trade, corresponding a financial sheet, is generated. In this case, the data combining section 290 watches the confirming flag of each item. When all of the confirming flags are turned on, all processes of confirming the text data about the financial sheet are completed.

The financial trade processing section 300 performs a financial trade based on the text data confirmed and combined by the data combining section 290, and it stores the text data in the database 250.

<Operation>

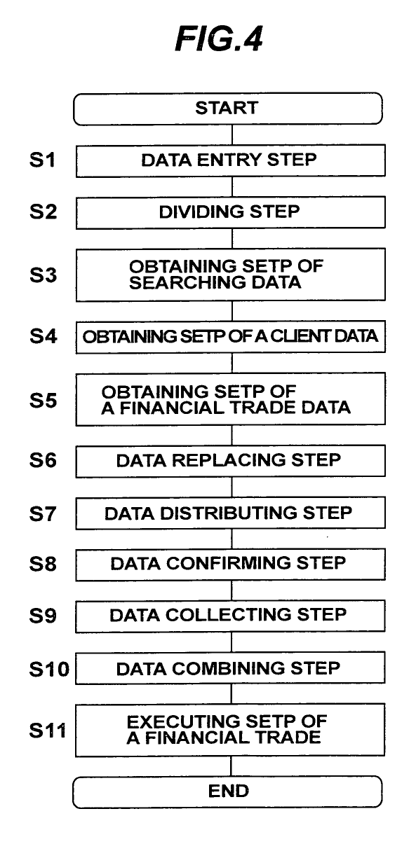

Subsequently, an operation of a data confirming system 10 of the present invention will be described, referring to a flow chart of FIG. 4.

When an entry terminal 40 has obtained an image data of a financial sheet by an image reader 41 and has obtained a text data corresponding to the image data by an OCR process of a character reader 42, the entry terminal 40 sends these data to a center apparatus 20 via a first network 30 (step S1).

When the center apparatus 20 obtained the image data and the text data of a financial sheet from the entry terminal 40, a data dividing section 220 of the center apparatus 20 divides these image data and text data into each item (step S2).

A searching data obtaining section 230 obtains each divided text data and each divided image data of; a telephone number of a client, a deposit number of a trade accepter, and a division of a deposit; as a searching data (step S3).

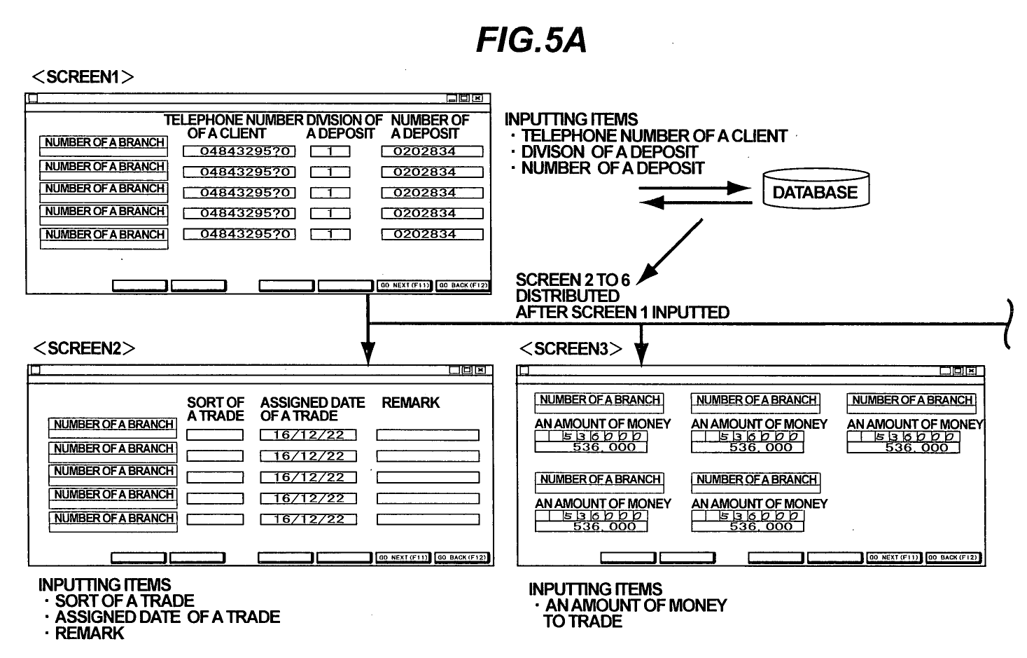

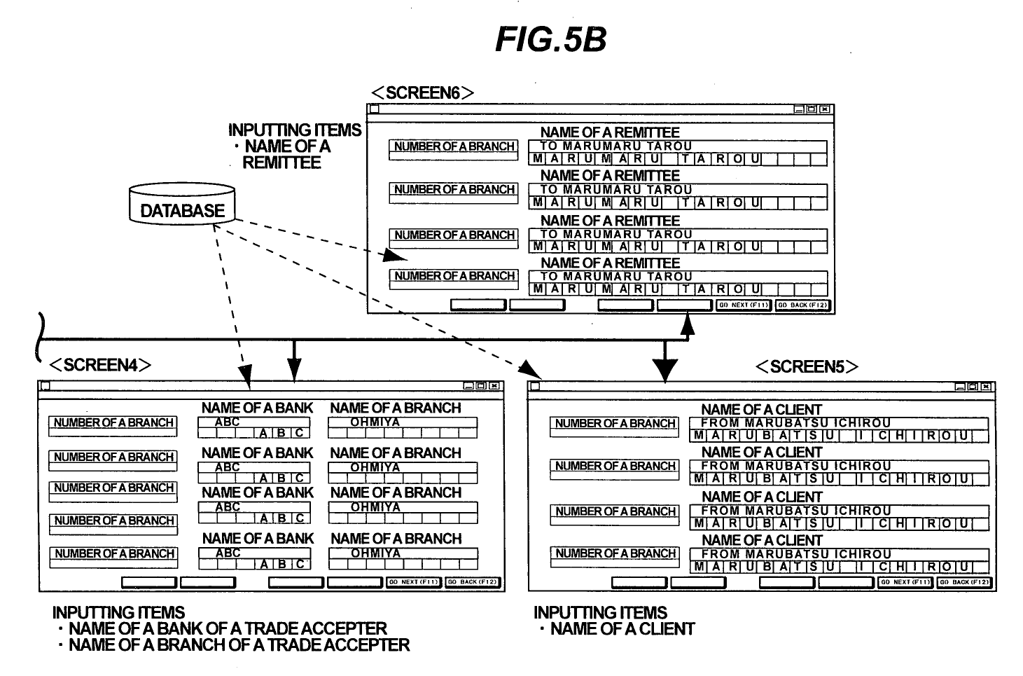

The obtained searching data is presented at a searching data confirming section 240. As shown in a screen 1 of FIG. 5A, each item of the text data and the image data are presented at a same screen. An operator at the center apparatus 20, confirms the text data according to the image data. When the operator finds an error in the text data, the operator corrects the error.

A database searching section 260 searches the database 250 based on the confirmed searching data, and it obtains a client data stored in the database 250 (step S4). Further, the database searching section 260 obtains a past financial trade data based on a deposit number of a trade accepter and a division of the deposit (step S5).

After this, the database searching section 260 puts out the obtained financial trade data to the data distributing section 270.

The data distributing section 270 which has obtained a financial trade data, obtains a name of a client, a name of a financial organ of the client, a name of a branch of the financial organ, a deposit number, and a division of the deposit, and it obtains a name of a trade accepter, a name of a financial organ of the trade accepter, and a name of a branch. After this, the data distributing section 270 replaces each item of the text data divided by the data dividing section 220, with each item of the text data obtained from the database 250.

That is, the data distributing section 270 replaces, for example, an item of the text data of a client name divided by the data dividing section 220, with an item of the text data of a client name obtained from the database 250. And, the data distributing section 270 replaces items of the text data of a client's financial organ name, its branch name, its deposit number, and its deposit division divided by the data dividing section 220, with items of the text data obtained from the database 250. Further, the data distributing section 270 replaces items of the text data of a trade accepter's name, his financial organ name, and its branch name divided by the data dividing section 220, with items of the text data obtained from the database 250 (step S6).

When the data distributing section 270 has replaced the text data, it distributes each item of the text data and the image data to each of the confirming terminals 60 (step S7).

For example, in case where there are five confirming terminals 60, as shown in FIGS. 5A and 5B, each of the confirming terminals 60 present each of screens 2 to 6.

Incidentally, the screen 2 presents a sort of a financial trade, an assigned date of the financial trade, and remarks; the screen 3 presents an amount of money to trade; the screen 4 presents a financial organ name of a trade accepter, its branch name; the screen 5 presents a name of a requesting client (a family name and a first name of a client); and the screen 6 presents a name of a remittee (a name of a trade accepter). In this case, the screens 4, 5 and 6 present contents that are replaced with contents searched from the database 250.

Each of the confirming terminals 60 confirm each item of the text data according to the corresponding image data (step S8).

In this case, it is not necessary for the terminals 60 that are presenting the screens 4, 5 and 6, to correct the text data; because each item of the text data presented at the screens 4, 5 and 6 are replaced with past financial trade data that are actually performed.

Each of the confirming terminals 60 output the confirmed text data to the center apparatus 20.

In the center apparatus 20, a data collecting section 280 collects each item of the confirmed text data (step S9), and a data combining section 290 combines the collected text data, so as to generate a text data of a financial trade (step S10).

A financial trade processing section 300 performs a financial trade according to the text data generated by the data combining section 290, and it stores the text data of the financial trade in the database 250 (step S10).

<Effects>

According to Embodiment 1, by steps of confirming a text data for searching the database 250 for a past financial trade data, obtaining a past financial trade data based on the searching data, obtaining each item of a financial trade data, replacing each item of text data obtained from an entry terminal 40 and divided by a dividing section 220, with each of the text data obtained from the past financial trade data: an efficient confirming process can be performed; because it is not necessary to correct the text data, as each item of the text data are replaced with past financial trade data that are actually performed.

### Other Embodiments

Although the present invention has been described in terms of the preferred embodiment, it goes without saying that the invention is not to be limited to this embodiment. And it can be embodied in various embodiments within the region of the invention defined in the claims appended after this description.

First of all, in the embodiment 1, the searching data confirming section 240 is installed in the center apparatus 20. However, the present invention is not limited to this. The function of the searching data confirming section 240 can be performed by a prescribed confirming terminal 60, so as to confirm the searching data by the prescribed confirming terminal 60 which is installed ouside of the cooperation center 1.

Moreover, in above embodiment 1, the searching data of a telephone number of a requesting client presented at the screen 1 of the data confirming section 240 of the center apparatus 20, is confirmed, before searching the database 250. However, the other searching data, that is, the deposit number of a trade accepter and the deposit division, can be presented at the other screen (not shown in the drawings) of the center apparatus 20 or at the other screen (not shown in the drawings) of other confirming terminal, so as to confirm the searching data. In this case, as mentioned in the embodiment 1, the deposit number of the requesting client and the deposit division can be adopted as the searching data, and these data can be presented at the screen 1 of FIG. 5A, or can be presented at the other screen (not shown in the drawings) of other confirming terminal, so as to confirm the searching data. After confirming all the searching data, the database 250 is searched (the claims 2, 8). Thus, the searching data can be more accurately confirmed.

When the deposit number of the requesting client and the deposit division is not adopted as the searching data (the claims 3, 9), the searching data can be quickly confirmed and a searching of the database 250 can be quickly started.

When the deposit number of the requesting client and the deposit division is adopted as the searching data (the claims 4, 10), the database 250 can be more accurately searched.

By the way, in above embodiment 1, the text data that are not replaced by a past financial trade data, that is, an assigned date of a remitting and an amount of money to trade, as shown in the screen 2 and 3 of FIG. 5A, are presented before confirming the searching data (the claims 5, 11), so as to give a sufficient time for each operator to confirm each of these items. However, these items can be distributed with other items, so as to simplify the distributing process.

Moreover, in above embodiment 1, each of the text data are replaced with each of the corresponding text data from the database 250 (the claims 6, 12), so as to perform a efficient confirming process. However, each of the text data from the entry terminal 40, can be presented without replacing by the past data, when the past data is same as the present data, or even when both data are different, the present data can be presented with the past data, so as to perform a confirming process by an operator.

In addition, though, in the embodiment 1, the replaced data are presented at screens 4, 5 and 6, as shown in FIG. 5B. However, in case where these data are accurate enough to omit the confirming process by operators; only the searching data and the data that are not searched from the database 250, can be presented at screens 1, 2 and 3, as shown in FIG. 5A, and the confirming process is completed by confirming only these data (the claim 13), so as to simplify the confirming process and to reduce the number of the operators.

What is claimed is:

1. A data confirming system comprising:
an image reader for reading an image of a manuscript written on a financial sheet,
a character reader for transforming said image to each of text data corresponding to said image,
a data dividing section for dividing said image and said text data, into each item in said financial sheet,
a searching data obtaining section for obtaining a searching data from said text data divided into said item,
a searching data confirming section for confirming said searching data,
a database for storing each financial trade data made in each past financial trade,
a data searching section for searching said database for a financial trade data corresponding to said searching data, and
a data distributing section for distributing each item of said financial trade data to each of confirming terminals, after extracting each item of said financial trade data from said financial trade data which is searched from said database.

2. A data confirming system according to claim 1 wherein said searching data confirming section completes a confirmation of said text data when said searching data confirming section receives from each of said confirming terminals a message informing each confirmation of each text data divided into each item in said financial trade data.

3. A data confirming system according to claim 1 wherein said searching data is a telephone number of a client of a financial trade, a number of a deposit of a trade accepter, and a division of a deposit of said trade accepter.

4. A data confirming system according to claim 1 wherein said searching data is a telephone number of a client of a financial trade, a number of a deposit of said client of a financial trade, a division of a deposit of said client of a financial trade, a number of a deposit of a trade accepter, and a division of a deposit of a trade accepter.

5. A data confirming system according to claim 1 wherein said data distributing section distributes at least an item of said financial trade data which is not searched from said database, before said data searching section starts searching said database.

6. A data confirming system according to claim 1 wherein said data distributing section comprising:
a replacing section for replacing said text data by each item of said financial trade data.

7. A data confirming method comprising steps of:
reading an image of a manuscript written on a financial sheet,
transforming said image to each of text data corresponding to said image,
dividing said image and said text data, into each item in said financial sheet,
obtaining a searching data from said text data divided into said item, confirming said searching data,
searching a database, corresponding to said searching data, for a financial trade data made in each past financial trade,
extracting each item of said financial trade data from said financial trade data which is searched from said database, and
distributing each item of said financial trade data to each of confirming terminals.

8. A data confirming method according to claim 7 further comprising a step of:
completing a confirmation of said text data after receiving from each of said confirming terminals a message informing each confirmation of each text data divided into each item in said financial trade data.

9. A data confirming method according to claim 7 wherein said searching data is a telephone number of a client of a financial trade, a number of a deposit of a trade accepter, and a division of a deposit of said trade accepter.

10. A data confirming method according to claim 7 wherein said searching data is a telephone number of a client of a financial trade, a number of a deposit of said client of a financial trade, a division of a deposit of said client of a financial trade, a number of a deposit of a trade accepter, and a division of a deposit of a trade accepter.

11. A data confirming method according to claim 7 further comprising a step of:
distributing at least an item of said financial trade data which is not searched from said database, before searching said database.

12. A data confirming method according to claim 7 further comprising a step of:
replacing said text data by each item of said financial trade data, before distributing to each of confirming terminals.

13. A data confirming system comprising:
an image reader for reading an image of a manuscript written on a financial sheet,
a character reader for transforming said image to a text data corresponding to said image data,
a data dividing section for dividing said image and said text data, into each item in said financial sheet,
a data distributing section for distributing to each of confirming terminals, a prescribed item of said text data which is obtained and divided from said financial sheet,
a searching data obtaining section for obtaining a searching data from said text data divided into said item,
a searching data confirming section for confirming said searching data,
a database for storing each financial trade data made in each past financial trade,
a data searching section for searching said database for a financial trade data corresponding to said searching data, and
a data replacing section for replacing other prescribed item of said text data which is obtained and divided from said financial sheet, with a corresponding item of said financial trade data which is extracted from said financial trade data.
